(19) United States
(12) Patent Application Publication
(10) Pub. No.: US 2025/0027894 A1
(43) Pub. Date: Jan. 23, 2025

(54) Flame Test Method

(71) Applicant: Avery Dennison Corporation, Mentor, OH (US)

(72) Inventors: Tien LY, Rosemead, CA (US); Ali R. MEHRABI, Glendale, CA (US); Luigi SARTOR, Arcadia, CA (US)

(21) Appl. No.: 18/773,768

(22) Filed: Jul. 16, 2024

Related U.S. Application Data
(60) Provisional application No. 63/513,946, filed on Jul. 17, 2023.

(51) Int. Cl. G01N 25/50; G01N 31/12

(52) U.S. Cl. CPC G01N 25/50; G01N 31/12

(57) ABSTRACT

Exemplary embodiments are directed to a flame test method. Generally, exemplary methods relate to a test method for laminate materials comprising a sample with a flammable layer and attaching this construction to a frame and exposing the construction to a frame. Specifically, exemplary methods relate to providing a sample, adhering a flammable layer to the sample resulting in a sample construction, attaching the sample construction to a frame, exposing the sample to a flame source, removing the flame source and inspecting the sample for fire damage.

### CROSS REFERENCE TO RELATED APPLICATIONS

The present application claims the benefit of U.S. Provisional Patent Application No. 63/513,946 filed Jul. 17, 2023, which is incorporated herein by reference in its entirety.

### TECHNICAL FIELD

This disclosure generally relates to a flame test method. Generally, exemplary methods relate to a test method for laminate materials comprising a sample with a flammable layer and attaching this construction to a frame and exposing the construction to a flame. Specifically, exemplary methods relate to providing a sample, adhering a flammable layer to the sample resulting in a sample construction, attaching the sample construction to a frame, exposing the sample to a flame source, removing the flame source and inspecting the sample for fire damage.

### BACKGROUND

Fire-related occurrences have caused widespread property damage and injuries. It is well known that a wide range of commonly used materials are flammable. To reduce the hazards from such flammable materials, flame retardants have been developed.

In order for polymeric materials to ignite, some form of degradation must occur. As polymers thermally decompose, they break down into generally volatile constituent molecules and free radicals that enter the vapor phase and combust with atmospheric oxygen if the temperature is above the ignition temperature, or a suitable ignition source is found. Combustion is an exothermic process which recycles thermal energy back into the underlying material, resulting in more material decomposition and feeding the combustion with additional fuel. The interface region between the flame and polymer is key as this allows the volatile constituent molecules and free radicals to continue to be generate the continuation of the reaction.

In order for a material to become flame retardant, the cycle must be interrupted to stop the fuel to be added to the fire. A flame starved of fuel will extinguish. Therefore, it is important to adequately develop materials and coatings that may act as thermally resistant and flame-retardant.

### SUMMARY

Exemplary embodiments relate to a test method comprising: providing a substantially planar sample comprising a front face and a rear face; adhering with an adhesive the sample to a substantially planar flammable layer comprising a front face and a rear face at the front face of the flammable layer to the rear face of the sample to result in a sample construction; attaching the sample construction to a frame, where at least a portion of the sample is attached to the frame and at least a portion is not attached to the frame; exposing the sample construction to a flame jet perpendicular to the front face of the sample for a period of time; deactivating the flame jet; inspecting the front face of the sample for the presence of fire damage; and inspecting the rear face of the flammable material for the presence of fire damage. This embodiment or another embodiment provides for the sample comprises a label material. This embodiment or another embodiment provides for the sample is generally circular in shape and has a diameter and the diameter is between about 0.5 and about 1.5 inches. This embodiment or another embodiment provides for the flammable layer comprises cellulose. This embodiment or another embodiment provides for the flammable layer is generally circular in shape and has a diameter less than a diameter of the sample and the diameter of the flammable layer is between about 0.25 and about 1.25 inches. This embodiment or another embodiment provides for the adhesive is a pressure sensitive adhesive. This embodiment or another embodiment provides for the frame comprises aluminum. This embodiment or another embodiment provides for the frame has at least one aperture. This embodiment or another embodiment provides for the at least one aperture is circular in shape. This embodiment or another embodiment provides for the at least one aperture has a diameter less than a diameter of the sample and less than a diameter of the flammable layer. This embodiment or another embodiment provides for the at least one aperture diameter is between about 0.25 and 0.75 inches. This embodiment or another embodiment provides for a ratio of the diameter of at least one aperture and the diameter of the sample is between about 1:6 and about 2:3. This embodiment or another embodiment provides for a ratio of the diameter of the diameter of at least one aperture and the diameter of the flammable layer is between about 1:5 and about 1:1. This embodiment or another embodiment provides for the frame has at least one circular aperture and the sample and the flammable layer are each circular shape and are concentric with respect to each other. This embodiment or another embodiment provides for activating further comprises: triggering a solenoid nearly concurrently to detecting a flame from the flame jet. This embodiment or another embodiment provides for opening a shield gate in operative connection with the solenoid. This embodiment or another embodiment provides for closing the shield gate. This embodiment or another embodiment provides for placing the flame jet about 0.5 to about 1.5 inches away from the sample construction. This embodiment or another embodiment provides for exposing the sample construction to the flame jet is in between about 1 and about 3 seconds. This embodiment or another embodiment provides for recording data resulting from observations from inspecting the sample construction.

### BRIEF DESCRIPTION OF THE DRAWINGS

FIG. 1 is a side view illustration of a test method in progress.

FIG. 2 is a front view illustration of a sample set up for the test method.

FIG. 3 is a perspective view of an exemplary system set up to carry out the test method.

FIG. 4 is a result of a test method having been carried out on samples.

### DEFINITIONS

As used herein, the term “substantially planar” refers to a surface or an object that is mostly flat or nearly flat, with only minor variations or deviations from a perfect plane. Such a surface or article has a predominately flat, even or level profile, although it may possess slight irregularities, or small degrees of curvature.

As used herein, the term “substantially perpendicular” refers to the orientation of one article with respect to another, where the surface is nearly or closely perpendicular to each other. This designation indicates that the articles are positioned as an angle close to 90 degrees, although there may be a slight deviation or tolerance from perfect perpendicularity.

As used herein, the term “substantially circular” refers to an aperture, surface, or object that is mostly or nearly circular in nature, with only minor variations or deviations from a perfect circle. Such an aperture, surface, or object may possess slight irregularities, or small degrees of curvature.

As used herein, “gsm” means grams per square meter.

As used herein, the term “multilayer” means, with respect to laminate construction, the adhesive coated face material with one or more additional layers. Non-limiting examples of such layers to make up the multilayer include protective layers, spacing layers, adhesive layers, optical component-containing layers, metallic layers, barrier layers, release liners, tie coat layers, clear layers, color layers, white layers, reflective layers, fluid transfer layers, strength promoting layers, topcoats, print receptive layers, print containing layers, indicia layers, functional layers, and the like as well as combinations thereof. The resultant multilayer laminate construction described herein can be used for a variety of applications including, but not limited to, graphics applications, such as automobile and architectural wraps; reflective applications, such as road and traffic signs, trains and other commercial vehicles, etc.; and label and packaging applications for battery labels and beyond.

### DETAILED DESCRIPTION

### Adhesives

The laminates/constructs described herein contain one or more adhesives. The adhesive(s) can be a PSA, a non-pressure sensitive adhesive, a hot-melt adhesive, or combinations thereof. In some embodiments, the adhesive is a PSA. The PSA may be any known PSA. In some embodiments, the PSA is a solvent type adhesive, an emulsion type adhesive, or non-emulsion type adhesive. In some embodiments, the PSA is an emulsion adhesive. Hot melt PSAs may also be used. The adhesive may be acrylic or any other useful adhesive which has the hardness and adhesive properties needed for the laminates and/or adhesive coated facestocks. In certain embodiments, the adhesive should have a hardness sufficient to prevent the adhesive squeezing out of the laminate or article during processing.

Exemplary PSAs may be found in (1) Encyclopedia of Polymer Science and Engineering, Vol. 13, Wiley-Interscience Publishers (New York, 1988); (2) Polymer Science and Technology, Vol. 1, Interscience Publishers (New York, 1964); (3) those described in U.S. Pat. Nos. 5,164,444; 5,183,459; and 5,264,532, all issued to Bernard, and U.S. Pat. No. 5,385,965, issued to Bernard et al; and (4) combinations thereof. The PSAs may be a solvent based or may be a water based adhesive. Conventional PSAs, including acrylic-based PSAs, rubber-based PSAs and silicone-based PSAs may be used in the laminates/constructs described herein. In one embodiment, the pressure sensitive adhesive contains an acrylic emulsion adhesive.

In some embodiments, the pressure sensitive adhesive is prepared by polymerizing alkyl acrylates, vinyl esters, diesters of dicarboxylic acids and unsaturated acids. The alkyl acrylates typically contain from about 2 to about 12, or from about 4 to about 8 carbon atoms in the alkyl group. Examples of alkyl acrylates include, but are not limited to, ethyl, n-butyl, hexyl, 2-ethylhexyl, and isooctyl acrylates, with 2-ethylhexyl acrylate preferred. In one embodiment, the alkyl acrylates are present in an amount of at least about 35%. In some embodiments, the alkyl acrylates are present in an amount from about 35% to about 60% by weight.

The vinyl esters typically have from about 2 to about 12, or from about 4 to about 8 carbon atoms in the alkyl group. Examples of vinyl esters include, but are not limited to, vinyl acetate, vinyl propionate, vinyl butyrate, vinyl versatate and the like, with vinyl acetate being preferred. In some embodiments, the vinyl esters are present in an amount from about 15% to about 35% or from about 20% to about 25% by weight.

The diesters of the dicarboxylic acids include alkyl esters of unsaturated diacids, such as maleic acid or anhydride and fumaric acids. The alkyl group generally contains from about 2 to about 20, or from about 4 to about 16, or from about 6 to about 12 carbon atoms. Examples of diesters of diacids include, but are not limited to, butyl, octyl fumarate; hexyl, decyl maleate; di-2-ethylhexyl maleate; di-butyl fumarate; and di-2-ethylhexyl fumarate and mixtures thereof. In some embodiments, the diesters of diacids are present in an amount from about 20% to about 35% by weight.

The unsaturated acids generally contain from about 2 to about 12, or from about 2 to about 6 carbon atoms. Examples of the unsaturated acids include, but are not limited to, acrylic acid, methacrylic acid, itaconic acid, and the like. In some embodiments, the unsaturated acids are present in an amount up to 5% or from about 1% to about 3% by weight.

In exemplary embodiments, the coat weight of adhesives may be between 2 and 100 gsm.

### Face Material

Suitable face materials include, but are not limited to, synthetic papers such as polyolefin type and polystyrene type; various plastic films or sheets such as polyolefin, polyvinyl chloride, polyethylene terephthalate, polystyrene, polyurethane, polymethacrylate and polycarbonate. Additional examples of suitable face materials include paper and cardboard. The face material may be, or may include, a multilayer polymeric sheet. The multi-layers may be coextruded, or the multi-layers may be laminated together. In one embodiment, the face material includes both co-extruded multi-layers and laminated multi-layers. In addition, a white opaque film may be formed by adding a white pigment to one or more of the aforementioned synthetic resins and used as the face material. In one embodiment, a foamed film is used as the face material. The foamed film may be formed by a conventional foaming operation. In another embodiment, the face material may be a laminated body formed by combining a plurality of single layered sheets composed of the above listed materials. Examples of such a laminated body may include the combination of cellulose fiber paper with synthetic paper, and a laminated body of combined cellulose fiber paper with a plastic film or sheet. In another suitable embodiment, the face material includes coated and uncoated papers, metalized papers, aluminum foil, laminated paper and paper with a polymeric material extruded onto the surface of the paper. In certain versions, the face material can be coated with a liquid absorbent material. The selected face material may be porous or semi-porous. The face material may exhibit certain visibility characteristics such as opaqueness, color, and/or brightness. The face material may include water or other liquid absorbency properties. The face material may be electrically conductive and/or include electrically conductive coatings or regions. A wide array of commercially available face materials can be used such as for example those available under the designation TESLIN.

The thickness of the face material is optionally determined with reference to application specific criteria. Such criteria may include the desired end use. In one embodiment, the sheet thickness is in a range of from about 10 μm to about 300 μm. In another embodiment, the sheet thickness is in a range of from about 20 μm to about 200 μm. In still another embodiment, the sheet thickness is in a range of from about 30 μm to about 150 μm. Optionally, a primer treatment or a corona discharging treatment or a plasma treatment may be used on the face material to increase a bonding strength between the face material and a dried topcoat composition to be formed on a surface of the face material.

In certain embodiments described herein, the face material exhibits one or more functions or functional characteristics. For example, the face material may be selected to enable or promote an indication such as a visual indication of a liquid, outgassing such as directing or allowing flow of air or gas across a thickness of the face material, water or liquid retention within the face material, electrical discharge or conductivity of the face material, chemical delivery across a thickness of the face material, passage of sound across a thickness of the face material, and/or combinations of these functions or characteristics.

### Methods

Having discussed various components, exemplary test methods and methodologies of operation will be discussed.

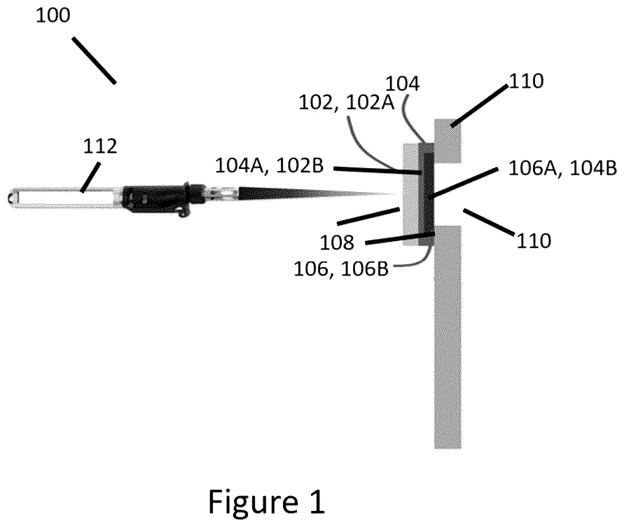

Referring specifically to FIG. 1, an illustration of a test method 100 in progress is shown. Specifically, a substantially planar sample 102 comprising a front face 102A and a rear face 102B is shown. This sample 102 is then attached at its rear face 102B to an adhesive component 104. The adhesive component 104 is then also adhered to a flammable layer 106 with a front face 106A and a rear face 106B. The adhesive component 104 touches the rear face 102B of the sample 102 and the front face 106A of the flammable layer 106. The sample 102, adhesive component 104 and flammable layer 106 are together a sample construction 108. The sample construction 108 is then attached to a frame 110. At least a portion of the sample construction 108 is attached to the frame 110 and at least a portion is not attached to the frame 110. The sample construction 108 is then exposed to a flame source 112 that is perpendicular to the front face 102A of the sample 102.

In one embodiment, the sample 102 is generally a laminate structure. In another embodiment it is a label material. The sample 102 is cut out or pressed out into a substantially circular shape and has a diameter between about 0.5 and about 1.5 inches.

In one embodiment the adhesive 104 can be any adhesive. In other embodiments, the adhesive 104 is a pressure sensitive adhesive. In one embodiment the flammable layer 106 is made of filter paper. In this or another embodiment, the flammable layer 106 is made of cellulose. In a specific example, the flammable layer 106 is a Whatman® paper filter #3 (by Cytiva Marlborough, MA, USA). The flammable layer 106 is cut out or pressed out into a substantially circular shape and has a diameter between about 0.25 and about 1.25 inches.

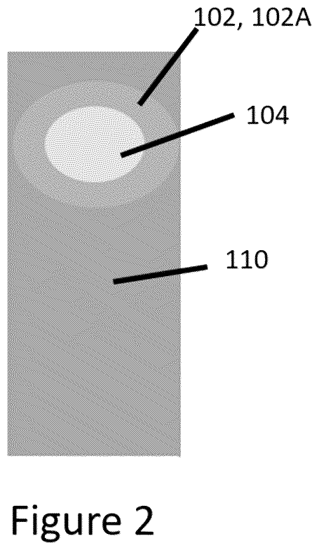

In the exemplary embodiment the frame 110 is aluminum, but may be any metal or alloy that has a melting point above 400° C. The frame 110 includes at least one aperture 110A, and in the exemplary embodiment the aperture is circular in nature. A diameter of the at least one aperture is less than the diameter of the sample and of the flammable layer. In the exemplary embodiment, the diameter is between about 0.25 and about 0.75 inches. Further, in the exemplary embodiment, a ratio of the diameter of at least one aperture and the diameter of the sample is between about 1:6 and about 2:3 and a ratio of the diameter of the diameter of at least one aperture and the diameter of the flammable layer is between about 1:5 and about 1:1. Each of the at least one aperture, the sample and flammable layer, all being circular are also concentric with respect to one another, as can be seen in FIG. 2. In one embodiment, the flame source is a flame jet. In an exemplary embodiment, the flame source is applied to the sample between about 1 and about 3 seconds. In another embodiment, the flame source is applied to the sample at about 2 seconds.

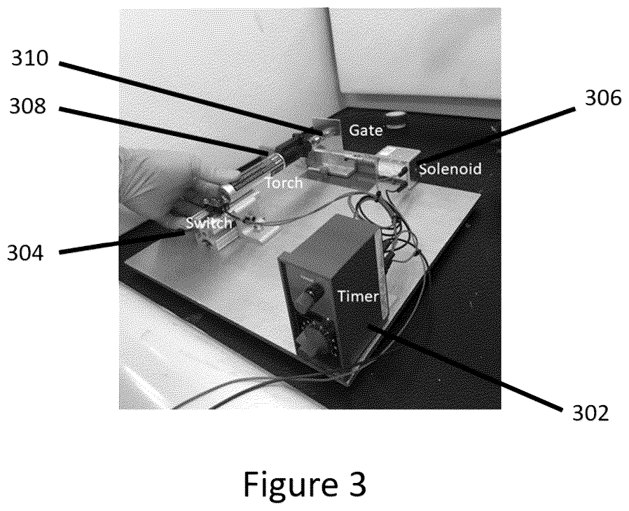

Referring now to FIG. 3, an exemplary system for to use the test method is shown. In this Figure, one can see a timer 302 operatively connected to a switch 304 and a solenoid 306. The switch 304 is then operatively connected to a flame source 308, in this case a torch, while the solenoid is operatively connected to a gate 310. The timer 302 is set to a value of seconds. This value of seconds will trigger the switch 304 prior to the time frame beginning to begin the flame from the flame source 308. Then, the gate 310 can be activated by the solenoid 306 and expose a sample to be tested. Then, when the timer 302 reaches its value, the switch 304 is operative to turn off the flame source 308 while the solenoid 306 will move the gate 310 back to its starting position as shown in the figure.

An exemplary method comprises providing a substantially planar sample comprising a front face and a rear face; adhering with an adhesive the sample to a substantially planar flammable layer comprising a front face and a rear face at the front face of the flammable layer to the rear face of the sample to result in a sample construction; attaching the sample construction to a frame, where at least a portion of the sample is attached to the frame and at least a portion is not attached to the frame; exposing the sample construction to a flame source substantially perpendicular to the front face of the sample for a period of time; removing the flame source; inspecting the label material for the presence of fire damage; and inspecting the rear face of the flammable material for the presence of fire damage.

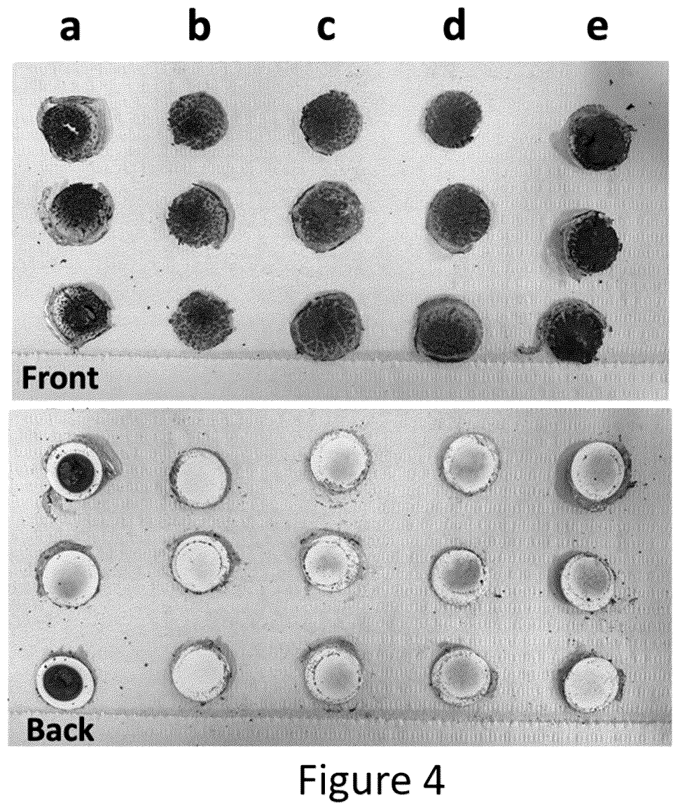

The results of this may be seen in FIG. 4. Specifically, five different flame-retardant label materials were tested in triplicates and both front (label side) and back (flammable side) of the samples were observed for the flame damage. For all of these samples the duration of the flame source exposure was 2 seconds. Upon observation it is clear that the sample (a) performed the worst since the front side is the most charred and the back side is completely charred for two samples out of three. On the contrary, sample (b) performed the best since the front and the back side charred the least. The performance of samples (c), (d), and (e) were similar and fall in between samples (a) and (b).

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0. % of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

We claim:

1. A test method comprising:
providing a substantially planar sample comprising a front face and a rear face;
adhering with an adhesive the sample to a substantially planar flammable layer comprising a front face and a rear face at the front face of the flammable layer to the rear face of the sample to result in a sample construction;
attaching the sample construction to a frame, where at least a portion of the sample is attached to the frame and at least a portion is not attached to the frame;
exposing the sample construction to a flame jet perpendicular to the front face of the sample for a period of time;
deactivating the flame jet;
inspecting the front face of the sample for the presence of fire damage; and
inspecting the rear face of the flammable material for the presence of fire damage.

2. The test method of claim 1, wherein the sample comprises a label material.

3. The test method of claim 1, wherein the sample is generally circular in shape and has a diameter and the diameter is between about 0.5 and about 1.5 inches.

4. The test method of claim 1, wherein the flammable layer comprises cellulose.

5. The test method of claim 1, wherein the flammable layer is generally circular in shape and has a diameter less than a diameter of the sample and the diameter of the flammable layer is between about 0.25 and about 1.25 inches.

6. The test method of claim 1, wherein the adhesive is a pressure sensitive adhesive.

7. The test method of claim 1, wherein the frame comprises aluminum.

8. The test method of claim 1, wherein the frame has at least one aperture.

9. The test method of claim 8, wherein the at least one aperture is circular in shape.

10. The test method of claim 9, wherein the at least one aperture has a diameter less than a diameter of the sample and less than a diameter of the flammable layer.

11. The test method of claim 10, wherein the at least one aperture diameter is between about 0.25 and 0.75 inches.

12. The test method of claim 10, wherein a ratio of the diameter of at least one aperture and the diameter of the sample is between about 1:6 and about 2:3.

13. The test method of claim 10, wherein a ratio of the diameter of the diameter of at least one aperture and the diameter of the flammable layer is between about 1:5 and about 1:1.

14. The test method of claim 1, wherein the frame has at least one circular aperture and the sample and the flammable layer are each circular shape and are concentric with respect to each other.

15. The test method of claim 1, wherein activating further comprises:
triggering a solenoid nearly concurrently to detecting a flame from the flame jet.

16. The test method of claim 15, further comprising:
opening a shield gate in operative connection with the solenoid.

17. The test method of claim 16, further comprising:
closing the shield gate.

18. The test method of claim 1, further comprising:
placing the flame jet about 0.5 to about 1.5 inches away from the sample construction.

19. The test method of claim 1, wherein exposing the sample construction to the flame jet is in between about 1 and about 3 seconds.

20. The test method of claim 1, further comprising:
recording data resulting from observations from inspecting the sample construction.
